(19) United States
(12) Patent Application Publication
(10) Pub. No.: US 2014/0346074 A1
(43) Pub. Date: Nov. 27, 2014

(54) Packaging Structure and Method

(71) Applicant: USERSTAR INFORMATION SYSTEM CO., LTD., Chiayi County (TW)

(72) Inventor: YIN-HUNG TSENG, Chiayi County (TW)

(73) Assignee: USERSTAR INFORMATION SYSTEM CO., LTD., Chiayi County (TW)

(21) Appl. No.: 14/279,944

(22) Filed: May 16, 2014

(30) Foreign Application Priority Data
May 24, 2013 (TW) 102118378

(51) Int. Cl. B65D 65/22; B65B 11/00; B65C 3/06; B65D 25/20

(52) U.S. Cl. CPC B65D 65/22; B65D 25/205; B65B 11/00; B65C 3/06
USPC 206/459.1; 53/410

(57) ABSTRACT

A packaging structure to package a target includes: a tag with a first portion being adhered to the target and a second portion wrapping the target; and a film wrapping and sticking the second portion of the tag. When the film is torn, the second portion of the tag is torn as well and the tag cannot be used to re-package.

### FIELD OF THE INVENTION

The present invention relates to packaging structure and method and, in particular, to package various targets such as containers.

### BACKGROUND OF THE INVENTION

There are many different kinds of liquid merchandise, such as drink, cosmetic, cooking oil and wine. These kinds of merchandise are filled in a container so that consumers are able to carry them.

Some kinds of the liquid merchandise are luxury. There can be a situation that providers provide counterfeit containers containing fake liquid or use real containers to contain fake liquid. Most consumers can only identify the liquid merchandise according to the appearance of containers, thus, consumers may be cheated when the providers are dishonest.

Some inventions provide packaging structure to help consumers identify whether the merchandise is real and packaged by the original manufacturer or not. For example, Taiwan patent No. M428168 provides a two-layer package to prevent the container packaging be damaged before it is sold; Taiwan patent No. M323083 provides a circuit tag to package the lip of a bottle. Both of the inventions disclose that breaking the package will tear the tag and which prevents someone filling fake contents into a used real container with real tag on the container.

Circuit tag, such as a tag with RFID on it, is used widely today. But the circuit tag is expensive, and making the packaging structure with a circuit tag is complicated now. A packaging with simple structure and function of counterfeit-protection is needed.

### SUMMARY OF THE INVENTION

The invention provides a packaging structure and a packaging method with simple structure and low manufacturer cost. The packaging structure and the packaging method of the present invention further have the function of anti-counterfeit.

The present invention provides a packaging structure for packing a target, comprising: a tag having a first portion with a first surface and a second portion with a second surface, the first surface and the second surface orientating in opposite directions, a first adhesive layer being provided on the first surface of the first portion, the tag being adhered to the target with the first adhesive layer sticking with the target and the second portion wrapping the target; and a film wrapping the second portion of the tag with a second adhesive layer provided between the film and the second surface of the second portion to adhere the film with the second adhesive layer; wherein the second surface of the second portion is damaged due to damage of the film.

The present invention further provides a packaging method to package a target, comprising: providing a tag with a first portion and a second portion; sticking the first portion of the tag on the target and wrapping the target with the second portion; and wrapping the second portion by a film with the film being adhered to the second portion.

The invention provides a simple packaging structure. With the packaging structure, the tag of the packaging structure is to be torn as the packaging structure is broken. Which makes the packaging structure has the feature of counterfeit-protection; meanwhile, the manufacturer cost of the packaging structure is low.

The invention provides a packaging structure and a packaging method. The packaging structure includes a film. The film is to protect the tag and the tag will not be broken or polluted before the packaging structure is broken.

The invention provides a packaging structure and a packaging method. The packaging structure includes a tag. A part of the tag will be torn as the packaging structure is broken, and the other part of the tag will not be torn as well. Some information of the container contents is recorded on the unbroken part of the tag, thus, users can read the information after a part of the tag is torn.

### BRIEF DESCRIPTION OF THE DRAWINGS

The invention will become more fully understood from the detailed description given herein below illustration only, and thus is not limitative of the present invention, and wherein:

FIG. 1A is a schematic diagram of a container on which the packaging structure of the present invention is applied;

FIG. 1B is a schematic diagram of another container on which the packaging structure of the present invention is applied;

FIG. 2 is an exploded view of the packaging structure according to a first embodiment of the present invention;

FIG. 3 is an assembled view of the packaging structure according to the first embodiment of the present invention;

FIG. 4 is a partially sectional view of the packaging structure according to the first embodiment of the present invention;

FIG. 5 is an assembled view of the packaging structure according to a second embodiment of the present invention;

FIG. 6 is an assembled view of the packaging structure according to a third embodiment of the present invention;

FIG. 7 is an assembled view of the packaging structure according to a fourth embodiment of the present invention;

FIG. 8 is a flow chart showing a packaging method to package a target of the present invention.

### DETAILED DESCRIPTION OF THE PREFERRED EMBODIMENT

The present invention will be apparent from the following detailed description, which reference to the accompanying drawings, wherein the same references relate to the same elements. The following paragraphs describe embodiments of the disclosed method and structure of packaging of the invention.

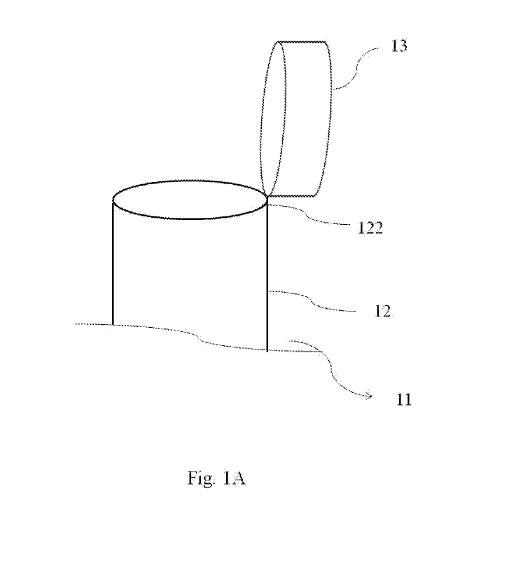

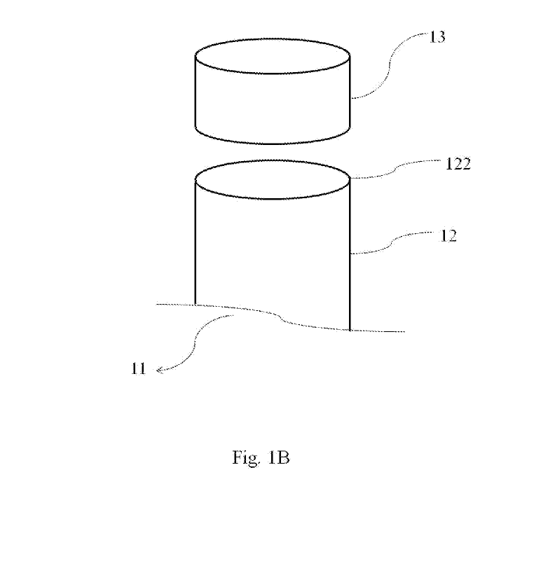

Please refer to FIG. 1A and FIG. 1B. FIG. 1A and FIG. 1B are schematic diagrams of different containers on which the packaging structure of the present invention is applied. As FIG. 1A and FIG. 1B shows, a container 11 includes a body 12 and a lid 13, wherein the body 12 further has a lip 122 covered by the lid 13. In an embodiment as FIG. 1A shows, a part of the lid 13 is connected with the body 12 in the condition of the lip 122 not being covered by the lid 13. In another embodiment as FIG. 1B shows, the lid 13 and the body 12 are able to be totally apart. In the present invention, the structure of the container 12 is not limited.

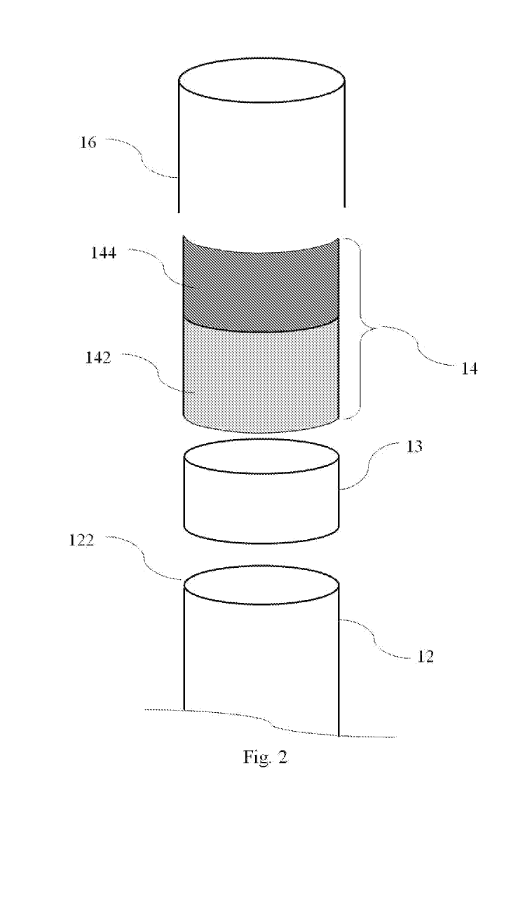

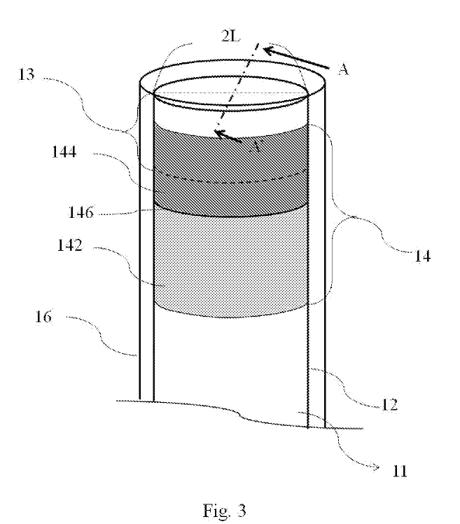

Please refer to FIG. 2 and FIG. 3. FIG. 2 and FIG. 3 are respectively an exploded view and an assembled view of the packaging structure according to a first embodiment of the present invention. As FIG. 2 and FIG. 3 show, packaging structure 1 includes a container 11 shown in FIGS. 1A & 1B, a tag 14 and a film 16, wherein the tag 14 further has a first portion 142 and a second portion 144. The lid 13 covers the lip 122 of the container 11. The tag 14 is across the junction of the body 12 and the lid 13 to adhere the body 12 and the lid 13; wherein the second portion 144 of the tag 14 adheres to the lid 13 and the body 12, meanwhile, the first portion 142 of the tag 14 adheres to the body 12. The film 16 wraps the first portion 142 and the second portion 144 of the tag 14 while the second portion 144 of the tag 14 is stuck with the film 16. Following will describe the detail structure of the first portion 142 and the second portion 144, also show how the tag 14 stick with the body 12 and the film 16.

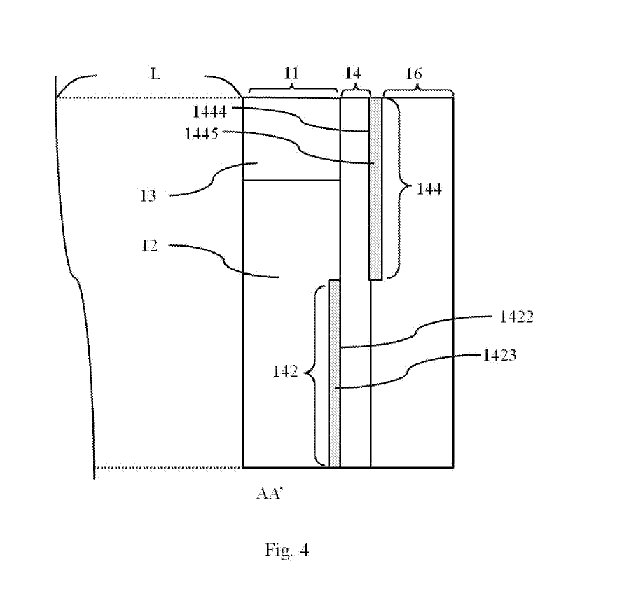

Please refer to FIG. 3 and FIG. 4. FIG. 4 is a sectional view of the packaging structure according to the first embodiment of the present invention. As FIG. 3 shows, the diameter of the container 11 is 2 L. FIG. 4 shows the section of a part of the container 11, the tag 14 and the film 16 according to a line AA′ of the packaging structure 1. The tag 14 includes a first portion 142 and a second portion 144, wherein the second portion 144 wraps the body 12 and the lid 13 of the container 11. The first portion 142 of the tag 14 further has a first surface 1422 on the inner side of the first portion 142, wherein an adhesive layer 1423 is provided on the first surface 1422. The first portion 142 is adhered to the body 12 of the container 11 with the adhesive layer 1423. The second portion 144 of the tag 14 further has a second surface 1444 on the outer side of the second portion 144, wherein an adhesive layer 1445 is provided on the second surface 1444. Obviously, the first surface 1422 and the second surface 1444 orientate in opposite directions. The film 16 is adhered to the second portion 144 of the tag 14 with the adhesive layer 1445, thus, the second surface 1444 of the second portion 144 is damaged duo to the damage of the film 16. For the first portion 142 is not stuck with the film 16, the first portion 142 will not be damaged due to damage of the film 16.

In an embodiment, the adhesive layer 1445 is part of the film 16. As the first portion 142 of the tag 14 adheres to the body 12 of the container 11 with the adhesive layer 1423, the film 16 adheres to the second portion 144 of the tag 14 with the adhesive layer 1445. Which makes this embodiment has the same features as that of the embodiment shown in the previous paragraph. In addition, the film 16 is tape in this embodiment.

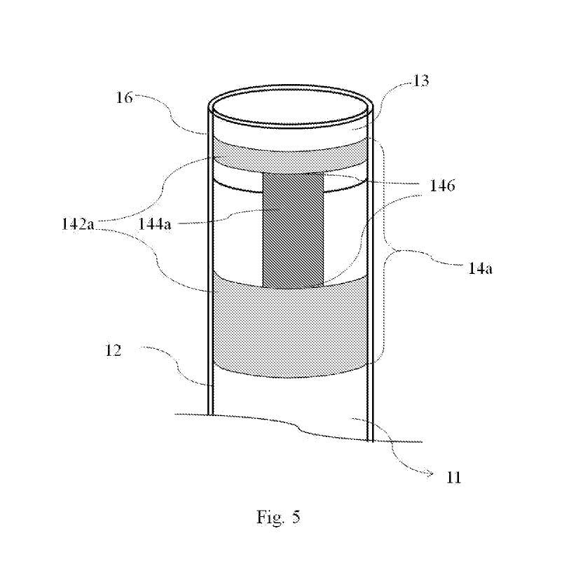

Please refer to FIG. 5. FIG. 5 is an assembled view of the packaging structure according to a second embodiment of the present invention. As FIG. 5 shows, packaging structure 2 includes a container 11 shown in FIGS. 1A & 1B, a tag 14a and a film 16, wherein the tag 14a further has a first portion 142a and a second portion 144a. The lid 13 covers the lip 122 of the container 11. The tag 14a is across the junction of the body 12 and the lid 13 to adhere the body 12 and the lid 13; wherein the second portion 144a of the tag 14a adheres to the lid 13 and the body 12. The first portion 142a of the tag 14a is divided into two portions and the two portions respectively adhere to the body 12 and the lid 13. The film 16 wraps the first portion 142a and the second portion 144a of the tag 14a while the second portion 144a of the tag 14a is stuck with the film 16. The structure of the tag 14a is similar to the tag 14 shown in the FIG. 4 and it is not to be described herein. The second portion 144a is damaged due to damage of the film 16. In addition, for the first portion 142a is not stuck with the film 16, the first portion 142a will not be damaged due to damage of the film 16.

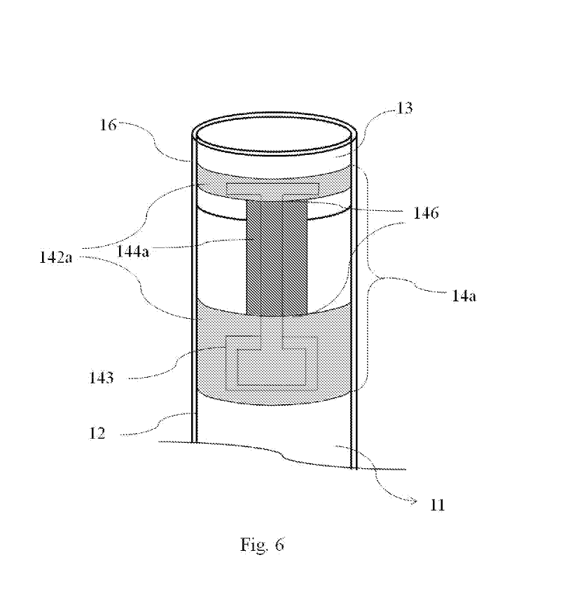

Please refer to FIG. 6. FIG. 6 is an assembled view of the packaging structure according to a third embodiment of the present invention. As FIG. 6 shows, packaging structure 3 includes a container 11 shown in FIGS. 1A & 1B, a tag 14a shown in FIG. 5 and a film 16, wherein the tag 14a is further provided with a circuit 143. One part of the circuit 143 is deposed on the first portion 142a and the other part of the circuit 143 is deposed on the second portion 144a. The structure and other units of the packaging structure 3 are similar to that of the packaging structure 2 and they are not to be described herein. As the second portion 144a of the tag 14 is damaged, the circuit 143 is broken. Thus, users can notice the tag 14a is damaged by scanning or reading the circuit 143 with an electrical device. The principle of how scanning or reading the circuit 143 is not the main feature of the present invention and it is not to be described herein.

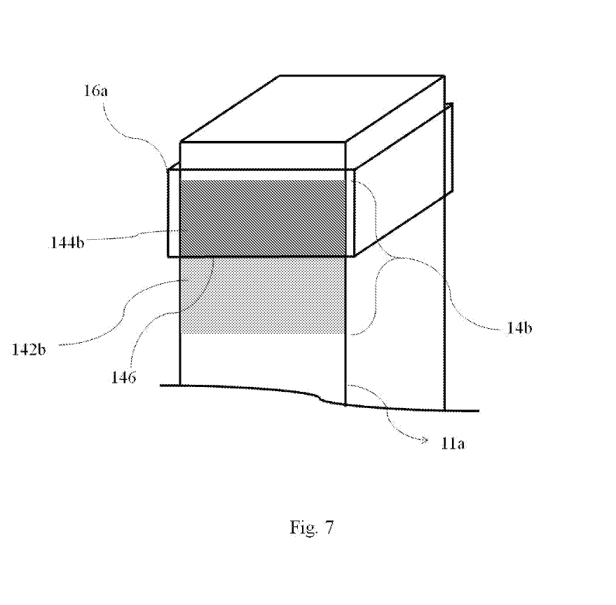

Please refer to FIG. 7. FIG. 7 is an assembled view of the packaging structure according to a fourth embodiment of the present invention. As FIG. 7 shows, packaging structure 4 is to package a target 11a. A tag 14b adheres to the target 11a, wherein a first portion 142b of the tag 14b adheres to the target 11a and a second portion 144b of the tag 14b wraps the target 11a. Furthermore, a film 16a adheres to the second portion 144b, and wraps the second portion 144b as well. As mentioned above, the packaging structures 1, 2, 3, 4 of the present invention not only can be used to package a container 11 with a body and a lid 13, but also can be used to package a target 11a. In an embodiment, the film 16, 16a wraps the whole tag 14, 14a, 14b; in another embodiment, the film 16, 16a just wraps the second portion 144, 144a, 144b of the tag 14, 14a, 14b. In the different embodiments, the second portions 144, 144a, 144b are damaged due to damage of the film 16, 16a.

Please refer to FIG. 3, FIG. 5, FIG. 6 and FIG. 7. As the figures show, in an embodiment, the tag 14 (or 14a, 14b) is provided a cutting line 146 formed between the first portion 142 (or 142a, 142b) and the second portion 144 (or 144a, 144b). When the second portion 144 (or 144a, 144b) is damaged as well as the film 16, the second portion 144 (or 144a, 144b) separates from the first portion 142 (or 142a, 142b) along the cutting line 146, thus, the first portion 142(or 142a, 142b) is not broken when the second portion 144 (or 144a, 144b) is damaged. In this embodiment, some information about the container 11 contents is recorded on the first portion, which allows users check the information after the packaging structure is broken. In an embodiment, the film 16, 16b is shrink film and is able to protect the tag 14, 14a, 14b.

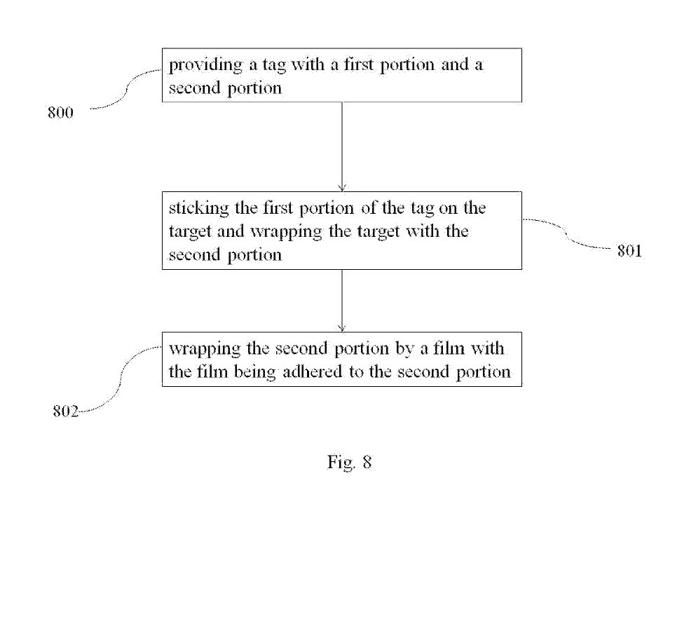

Please refer to FIG. 8. FIG. 8 is flow chart of the packaging method to package a target of the present invention. As FIG. 8 show, the packaging method to package a target 11 includes the steps of:

Step 800: providing a tag 14 shown in FIG. 2 (or a tag 14a shown in FIGS. 5 & 6, or a tag 14b shown in FIG. 7) with a first portion 142 (or 142a, 142b) and a second portion 144 (or 144a, 144b);

Step 801: sticking the first portion 142 of the tag 14 on the target 11 and wrapping the target 11 with the second portion 144; and

Step 802: wrapping the second portion 144 by a film 16 with the film 16 being adhered to the second portion 144.

The invention provides packaging structure 1 (or 2, 3, 4) with a film 16 on each of them to prevent the tags 14 (or 14a, 14b) of the packaging structures 1, 2, 3, 4 to be broken or polluted before the packaging structure 1 (or 2, 3, 4) is broken.

The invention provides packaging structures 1, 2, 3, 4 with simple units. Which makes the manufacturing cost of the packaging structures 1, 2, 3, 4 is low.

The packaging structures 1, 2, 3, 4 and the packaging method are able to package a container 11 or a target 11a well. The tag 14, 14a, 14b is damaged due to damage of the packaging structures 1, 2, 3, 4, which has the function of anti-counterfeit. Moreover, a first portion 142, 142a, 142b of the tag 14, 14a, 14b is not broken when the tag 14, 14a, 14b is torn. The First portion 142, 142a, 142b is able to provide information of the container 11 contents to users after the tag 14, 14a, 14b is torn.

Although the invention has been described with reference to the preferred embodiments, this description is not meant to be construed in a limiting sense. It is apparent to those skilled in the art that a variety of modifications and changes may be made without departing from the scope of the present invention which is intended to be defined by the appended claims.

What is claimed is:

1. A packaging structure for packing a target, comprising:
a tag having a first portion with a first surface and a second portion with a second surface, the first surface and the second surface orientating in opposite directions, a first adhesive layer being provided on the first surface of the first portion, the tag being adhered to the target with the first adhesive layer sticking with the target and the second portion wrapping the target; and
a film wrapping the second portion of the tag with a second adhesive layer provided between the film and the second surface of the second portion to adhere the film with the second adhesive layer;
wherein the second surface of the second portion is damaged due to damage of the film.

2. The packaging structure of claim 1, wherein the tag is further provided with a circuit one part of which is deposed on the first portion of the tag while the other part of the circuit is deposed on the second portion of the tag; and the circuit is broken due to damage of the second surface of the second portion.

3. The packaging structure of claim 1, wherein the film is a shrink film.

4. The packaging structure of claim 1, wherein the film is a tape.

5. The packaging structure of claim 1, wherein the tag is provided with a cutting line formed between the first portion and the second portion, and the second portion separates from the first portion along the cutting line due to damage of the film.

6. A packaging method to package a target, comprising:
providing a tag with a first portion and a second portion;
sticking the first portion of the tag on the target and wrapping the target with the second portion; and
wrapping the second portion by a film with the film being adhered to the second portion.
